(19) United States
(12) Patent Application Publication
(10) Pub. No.: US 2006/0130915 A1
(43) Pub. Date: Jun. 22, 2006

(54) Manual valve of automatic transmission

(76) Inventor: Jin Hee Lee, Seongnam-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,719

(22) Filed: Dec. 15, 2005

(30) Foreign Application Priority Data
Dec. 17, 2004 (KR) 10-2004-0108234
Dec. 23, 2004 (KR) 10-2004-0111358
Dec. 15, 2005 (KR) 10-2005-0123552

(51) Int. Cl. F15B 13/04

(52) U.S. Cl. 137/625.69

(57) ABSTRACT

The present invention relates to a manual valve of an automatic transmission, having a groove formed at an exterior surface thereof so as to reduce shock and to improve shift feel by allowing oil to flow through the groove when releasing hydraulic pressure. An exemplary manual valve of an automatic transmission includes a valve body and a valve spool slidably provided in the valve body. The valve body includes a spool receiving part, a first port, a second port, and a third port. The valve spool includes an underdrive land assembly and a reverse land assembly, wherein at least one of the underdrive land assembly and the reverse land assembly has a groove formed on an exterior circumference thereof along a sliding direction of the valve spool such that oil flows therethrough when hydraulic pressure is released.

### CROSS-REFERENCE TO RELATED APPLICATION

This application claims priority to and the benefit of Korean Patent Application No. 10-2004-0108234 filed in the Korean Intellectual Property Office on Dec. 17, 2004, Korean Patent Application No. 10-2004-0111358 filed in the Korean Intellectual Property Office on Dec. 23, 2004, Korean Patent Application No. 10-2005-0123552 filed in the Korean Intellectual Property Office on Dec. 15, 2005, the entire contents of which are incorporated herein by reference.

### BACKGROUND OF THE INVENTION

(a) Field of the Invention

The present invention relates to a manual valve of an automatic transmission. More particularly, the present invention relates to a manual valve of an automatic transmission having a groove formed at an exterior surface thereof so as to reduce shock and to improve shift feel by allowing oil to flow through the groove when releasing hydraulic pressure.

(b) Description of the Related Art

In a typical automatic transmission of a vehicle, hydraulic pressure applied to a U/D (underdrive) clutch should be released so as to change a shift range from a D range to an N range, and hydraulic pressure applied to a reverse clutch should be released so as to shift a shift range from an R range to an N range. Generally, releasing of the hydraulic pressure applied to the underdrive clutch and the reverse clutch is performed by using an orifice and a manual valve.

However, when the hydraulic pressure applied to the underdrive clutch or reverse clutch is abruptly released, a shock occurs and shift feel is problematically deteriorated.

Therefore, a method for tuning a size of the orifice is used so as to solve the above-mentioned problems, and to improve the shift feel when changing the shift range from D range to N range or from R range to N range.

However, if a size of the orifice is reduced so as to prevent immediate release of hydraulic pressure, the inflow speed of oil when applying hydraulic pressure to the U/D clutch or reverse clutch problematically becomes slower.

In addition, if the size of the orifice is reduced, a viscosity change of oil (ATF) according to a change of temperature significantly affects the shift feel.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a manual valve of an automatic transmission having advantages of reducing shock and improving shift feel by allowing oil to flow through the groove when releasing hydraulic pressure.

An exemplary manual valve of an automatic transmission according to an embodiment of the present invention includes a valve body and a valve spool slidably provided in the valve body. The valve body includes a spool receiving part for receiving the valve spool, a first port connecting the spool receiving part with an underdrive clutch, a second port connecting the spool receiving part with a reverse clutch, and a third port connecting the spool receiving part with a pump. The valve spool includes an underdrive land assembly for selectively opening/closing the first port, and a reverse land assembly for selectively opening/closing the second port, wherein at least one of the underdrive land assembly and the reverse land assembly has a groove formed on an exterior circumference thereof along a sliding direction of the valve spool such that oil flows therethrough when hydraulic pressure is released.

The underdrive land assembly may include a first land and a second land protruded at both end thereof, a plane part formed between the first land and the second land, and a groove formed on a exterior circumference thereof along a sliding direction of the valve spool. The spool receiving part has a larger diameter at a position where the first port is formed, the first port is disposed between the first land and the second land when in the N (neutral) range, and oil flows from the first port to the outside of the valve spool through the groove.

A penetration hole may be formed at the plane part.

A reverse land assembly may include a third land and a fourth land protruded at respective ends thereof, a plane part formed between the third land and the fourth land, and a groove formed on an exterior circumference thereof along a sliding direction of the valve spool, wherein the spool receiving part has a larger diameter at a position where the second port is formed, the second port is disposed between the third land and the fourth land when in the N (neutral) range, and oil flows from the second port to the outside of the valve spool through the groove.

A penetration hole may be formed at the plane part.

### BRIEF DESCRIPTION OF THE DRAWINGS

FIG. 1 is a perspective view of a valve spool according to an exemplary embodiment of the present invention.

FIG. 2 is a cross-sectional view of an underdrive land assembly according to an exemplary embodiment of the present invention.

FIG. 3 is a cross-sectional view of a reverse land assembly according to an exemplary embodiment of the present invention.

FIG. 4A is a schematic view of a manual valve according to an exemplary embodiment of the present invention.

FIG. 4B is a schematic view of a manual valve according to an exemplary embodiment of the present invention.

FIG. 5A is a schematic view of a manual valve according to an exemplary embodiment of the present invention.

FIG. 5B is a schematic view of a manual valve according to an exemplary embodiment of the present invention.

| | | | |
|---|---|---|---|
| 10: | underdrive clutch | 20: | reverse clutch |
| | (U/D clutch) | | (reverse clutch) |
| 30: | pump | 100: | valve spool |
| 110: | underdrive land assembly | 111: | first land |
| 112: | second land | 113: | plane part |
| 114: | penetration hole | 115: | groove |
| 120: | reverse land assembly | 121: | third land |
| 122: | fourth land | 123: | plane part |
| 124: | penetration hole | 125: | groove |
| 130: | connector | 140: | central shaft |
| 200: | valve body | 210: | first port |
| 220: | second port | 230: | third port |
| 240: | spool receiving part | | |

### DETAILED DESCRIPTION OF THE EMBODIMENTS

An exemplary embodiment of the present invention will hereinafter be described in detail with reference to the accompanying drawings.

A manual valve according to an exemplary embodiment of the present invention includes a valve body 200 and a valve spool 100.

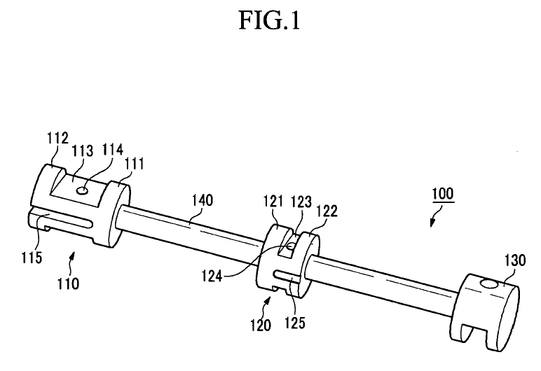

Hereinafter, referring to FIG. 1 to FIG. 3, a structure of the valve spool 100 according to an exemplary embodiment of the present invention will be described in detail.

The valve spool 100 according to an exemplary embodiment of the present invention includes a central shaft 140, an underdrive land assembly 110 formed at an end of the central shaft 140, a connector 130 formed at the other end of the central shaft 140 and being connected with a shift lever, and a reverse land assembly 120 formed between the underdrive land assembly 110 and the connector 130.

The underdrive land assembly 110 includes a first land 111 and a second land 112 protruded to have cylindrical shapes at respective ends thereof, a plane part 113 formed to be flat, and a groove 115 formed along a sliding direction of the valve spool at a exterior circumference of the underdrive land assembly 110.

The underdrive land assembly 110 has a cylindrical body, and a part of an exterior circumference of the cylindrical body is processed to be flat so as to form the plane part 113. The non-processed part still has a cylindrical shape at both ends of the plane part 113, which become the first land 111 and the second land 112.

A penetration hole 114 is formed at the center of the plane part 113.

The groove 115 is formed at the exterior circumference of the underdrive land assembly 110. One end of the groove 115 is blocked by the first land 111, and the other end thereof is open toward the outside of the second land 112.

The reverse land assembly 120 includes a third land 121 and a fourth land 122 protruded to have cylindrical shapes at both ends thereof, a plane part 123 formed to be flat, and a groove 125 formed along a sliding direction of the valve spool at an exterior circumference of the reverse land assembly 120.

The reverse land assembly 120 has a cylindrical body, and a part of an exterior circumference of the cylindrical body is processed to be flat so as to form the plane part 123. The non-processed part still has a cylindrical shape at both ends of the plane part 123, which become the third land 121 and the fourth land 122.

A penetration hole 124 is formed at the center of the plane part 123.

The groove 125 is formed at the exterior circumference of the reverse land assembly 120. One end of the groove 125 is blocked by the first land 121, and the other end thereof is open toward the outside of the second land 122.

The connector 130 is connected to a shift lever not shown in the accompanying drawings such that it causes the valve spool 100 to slide in the valve body 200.

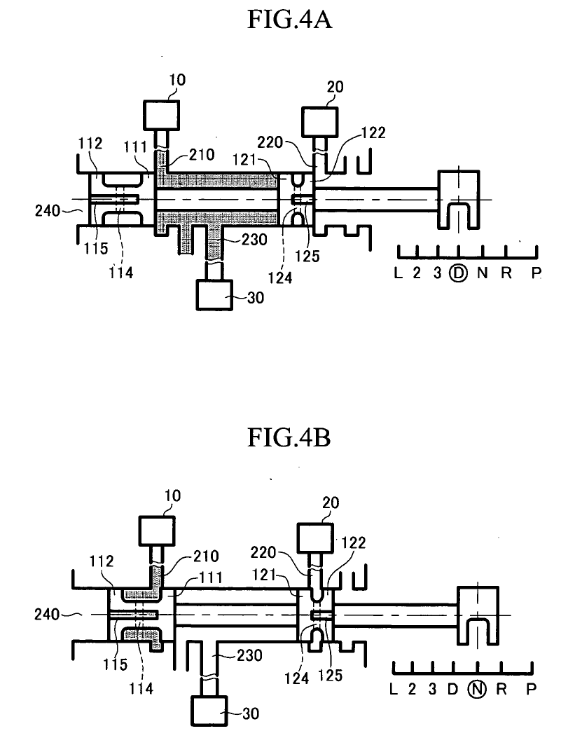

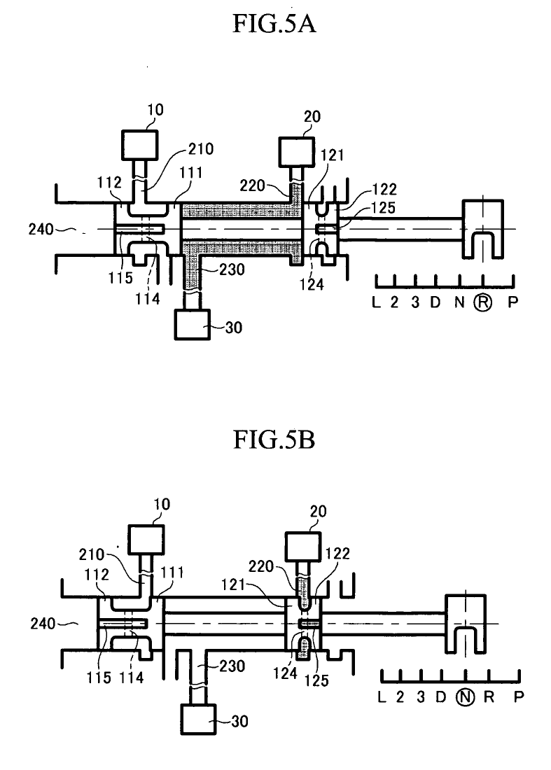

Hereinafter, referring to FIG. 4A to FIG. 5B, the valve body 200 according to an exemplary embodiment of the present invention will be described in detail.

The valve body 200 according to the present exemplary embodiment of the present invention includes a spool receiving part 240 wherein the valve spool 100 slides, a first port 210 connected with the underdrive clutch 10, a second port 220 connected with the reverse clutch 20, and a third port 230 connected with a pump 30.

The spool receiving part 240 is formed in the valve body 200 such that the valve spool 100 slides therewithin.

The spool receiving part 240 has a cylindrical shape having a diameter that is virtually the same as external diameters of the first land 111 to the fourth land 122. However, the diameter of the spool receiving part 240 becomes larger at positions where the first port 210 and the second port 220 are formed.

Therefore, oil (ATF) does not flow between the interior circumference of the spool receiving part 240 and the exterior circumference of the first land 111 to the fourth land 122, except at the. positions having larger diameters.

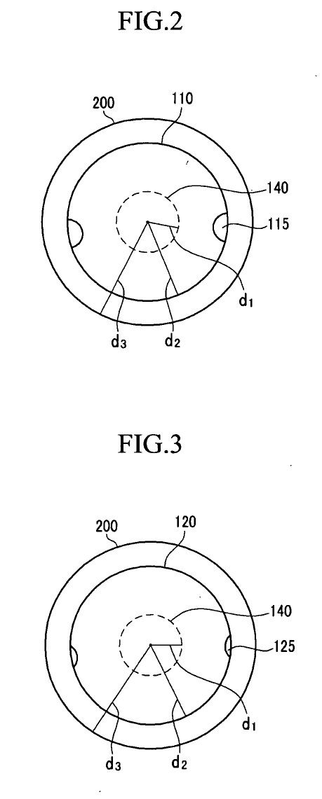

FIG. 2 shows a schematic cross-sectional view of the underdrive land assembly 110 being received in the valve body 200.

The underdrive land assembly 110 is formed to have a cylindrical shape having an inner diameter d2, and has the groove 115 formed at an exterior circumference thereof. Reference numeral 140 indicates the central shaft, shown by a dotted line and having a diameter d1 that is smaller than the diameter d2 of the underdrive land assembly 110.

The spool receiving part 240 of the valve body 200 has an inner diameter d2 that is virtually the same as the diameter of the underdrive land assembly 110. However, the spool receiving part 240 of the valve body 200 has an inner diameter d3 where the first port 210 is formed.

FIG. 3 shows a schematic cross-sectional view of the reverse land assembly 120 being received in the valve body 200.

The reverse land assembly 120 is formed to have a cylindrical shape having an inner diameter d2, and has a groove 125 formed at an exterior circumference thereof. Reference numeral 140 indicates the central shaft, shown by a dotted line and having a diameter d1 that is smaller than the diameter d2 of the reverse land assembly 120.

The spool receiving part 240 of the valve body 200 has an inner diameter d2 that is virtually the same as the diameter of the reverse land assembly 120. However, the spool receiving part 240 of the valve body 200 has an inner diameter d3 where the first port 210 is formed.

Hereinafter, referring to FIG. 4A to FIG. 4B, a process for operating a manual valve according to an exemplary embodiment of the present invention, when changing a shift range between D range and N range will be described in detail.

FIG. 4A shows a flow of oil where oil flowing into the spool receiving part 240 through the third port 230 from the pump 30 flows into the U/D clutch 10 through the first port 210.

When a driver moves a shift lever to the D range, the valve spool 100 moves such that the first land 111 is disposed outside the first port 210 (referring to FIG. 4A, left side of the first port). Then, the third port 230 and the first port 210 communicate with each other, and hydraulic pressure is applied to the underdrive clutch 10 by operation of the pump 30. At this time, the oil is blocked by the first land 111 and the third land 121 and exists in a space between the first land 111 and the third land 121, in the spool receiving part 240.

That is, since the first land 111 and the third land 121 have the diameter d2 that is virtually the same as a diameter of the spool receiving part 240, a flow of oil to the outside of the first land 111 and the third land 121 is prevented.

When the driver moves the shift lever from the D range to the N range, the valve spool 100 moves to the right, as shown in FIG. 4B, and the first port 210 is disposed between the first land 111 and the second land 112.

At this time, since the diameter d3 of the spool receiving part 240 where the first port 210 is larger than the diameter d2 of the underdrive land assembly 110, oil flows into the groove 115. Then, the oil flowing into the groove 115 flows out of the second land 112 through an opening of the groove.

At this time, some of the oil from the underdrive clutch 10 flows to the plane part 113 through the first port 210. The oil flowing to the plane part 113 is blocked by the first land 111 and the second land 122, and flows into the opposite plane part through the penetration hole 114. Therefore, a hydraulic pressure of both plane parts can be balanced.

According to the above-described operation of the manual valve whew shifting between D range and N range, since oil rapidly flows into the underdrive clutch 10, and slowly flows out of the underdrive clutch 10, shock does not occur and shift feel is improved to be smoother.

Hereinafter, referring to FIG. 5A to FIG. 5B, a process for operating a manual valve according to an exemplary embodiment of the present invention, when changing a shift range between R range and N range, will be described in detail.

FIG. 5A shows a flow of oil where oil flowing into the spool receiving part 240 through the third port 230 from the pump 30 flows into the reverse clutch 20 through the second port 220.

When the driver moves the shift lever to the R range, the valve spool 100 moves such that the third land 121 is disposed outside the second port 220 (referring to FIG. 5A, right side of the first port). Then, the third port 230 and the second port 220 communicate with each other, and hydraulic pressure is applied to the reverse clutch 20 by operation of the pump 30. At this time, the oil is blocked by the first land 111 and the third land 121 and exists in a space between the first land 111 and the third land 121, in the spool receiving part 240.

That is, since the first land 111 and the third land 121 have a diameter d2 that is virtually the same as a diameter of the spool receiving part 240, a flow of oil to the outside of the first land 111 and the third land 121 is prevented.

When the driver moves the shift lever from the R range to the N range, the valve spool 100 move to the left, as shown in FIG. 5B, and the second port 220 is disposed between the third land 121 and the fourth land 122.

At this time, since the diameter d3 of the spool receiving part 240 where the second port 220 is larger than the diameter d2 of the reverse land assembly 120, oil flows into the groove 125. Then, the oil flowing into the groove 125 flows out of the fourth land 122 through an opening of the groove.

At this time, some of the oil from the reverse clutch 20 flows to the plane part 123 through the second port 220. The oil flowing to the plane part 123 is blocked by the third land 121 and the fourth land 122, and flows into the opposite plane part through the penetration hole 124. Therefore, hydraulic pressure of both plane parts can be balanced.

According to the above-described operation of the manual valve when shifting between R range and N range, since oil rapidly flows into the reverse clutch 10, and slowly flows out of the reverse clutch 10, shock does not occur and shift feel is improved to be smoother.

Therefore, by adjusting a size of the groove, appropriate shift feel can be achieved.

According to the above-described present invention, when changing a shift range between D range and N range, or R range and N range, rapid releasing of hydraulic pressure is prevented. Therefore, shock is reduced, and shift feel is improved to be smoother.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A manual valve of an automatic transmission, comprising a valve body and a valve spool slidably provided in the valve body, wherein
the valve body comprises:
a spool receiving part for receiving the valve spool;
a first port connecting the spool receiving part with an underdrive clutch;
a second port connecting the spool receiving part with a reverse clutch; and
a third port connecting the spool receiving part with a pump, and the valve spool comprises:
an underdrive land assembly for selectively opening/closing the first port; and
a reverse land assembly for selectively opening/closing the second port, wherein
at least one of the underdrive land assembly and the reverse land assembly has a groove formed on an exterior circumference thereof along a sliding direction of the valve spool such that oil flows therethrough when hydraulic pressure is released.

2. The manual valve of claim 1, wherein
the underdrive land assembly comprises:
a first land and a second land protruded at respective ends thereof;
a plane part formed between the first land and the second land; and
a groove formed on a exterior circumference thereof along a sliding direction of the valve spool, wherein
the spool receiving part has a larger diameter at a position where the first port is formed,
the first port is disposed between the first land and the second land when in the N (neutral) range, and
oil flows from the first port to outside of the valve spool through the groove.

3. The manual valve of claim 2, wherein
a penetration hole is formed at the plane part.

4. The manual valve of claim 1, wherein
the reverse land assembly comprises:
a third land and a fourth land protruded at respective ends thereof;
a plane part formed between the third land and the fourth land; and
a groove formed on a exterior circumference thereof along a sliding direction of the valve spool, wherein
the spool receiving part has a larger diameter at a position where the second port is formed,
the second port is disposed between the third land and the fourth land when in the N (neutral) range, and
oil flows from the second port to outside of the valve spool through the groove.

5. The manual valve of claim 4, wherein
a penetration hole is formed at the plane part.
